(19) United States
(12) Patent Application Publication
(10) Pub. No.: US 2008/0246228 A1
(43) Pub. Date: Oct. 9, 2008

(54) Sealing Disk, in Particular for Sealing Off a Fuel Injector with Respect to an Engine Block, and Fuel Injector

(76) Inventors: Juergen Hanneke, Stuttgart (DE); Andreas Gaudl, Remshalden (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/091,711

(22) PCT Filed: Oct. 24, 2006
(86) PCT No.: PCT/EP06/67682

§ 371 Date: Apr. 25, 2008

(30) Foreign Application Priority Data
Nov. 4, 2005 (DE) 10 2005 052 674.8

(51) Int. Cl. F02M 61/14

(52) U.S. Cl. 277/595; 277/591

(57) ABSTRACT

According to the invention, a sealing disc (16) serves to seal off a fuel injector with respect to an engine block of an internal combustion engine. Said sealing disc (16) comprises an inner opening (24) and a captive securing means (28) for captive retention on the fuel injector. It is proposed according to the invention that the sealing disc (16) has, overall, at least one support layer (30) and at least two sealing layers (32, 34) arranged to each side of the support layer (30), wherein the support layer (30) is made from a stiffer material than the sealing layers (32, 34), and that the captive securing means comprises, at an edge of the inner opening, at least one radially inwardly extending lug-like projection (28).

### PRIOR ART

The invention relates to a sealing disk, in particular for sealing off a fuel injector with respect to an engine block, as generically defined by the preamble to claim 1. The subject of the invention is also a fuel injector as generically defined by the preamble to the coordinate claim.

German Patent Disclosure DE 199 41 930 A1 discloses a fuel injector for internal combustion engines that in the installed position is sealed off from an engine block of the engine by an annular sealing disk. To simplify assembly and to assure that the fuel injector is in fact secured to the engine block by such a sealing disk, the sealing disk, after the fuel injector has been manufactured, is slipped onto the fuel injector and retained in captive fashion on it.

It is the object of the present invention to create a sealing disk that is economical and that can be retained in captive fashion on a fuel injector at little expense.

This object is attained by a sealing disk having the characteristics of claim 1. A further option is disclosed in the coordinate claim, which pertains to a fuel injector. Advantageous refinements are defined by dependent claims.

### ADVANTAGES OF THE INVENTION

By means of the lug-like projection, a captive securing means is created, which by nonpositive and/or positive engagement reliably holds the sealing disk, for instance on a fuel injector. This reliable nonpositive or positive engagement is made possible by the support layer of a comparatively stiff material: When the sealing disk is slipped onto a fuel injector, for instance, the lug-like projection deforms elastically; because of the great stiffness of the support layer material, however, it rests on the workpiece with great force.

However, this great force and the deformation of the lug-like projection counter to the removal direction, which leads to a kind of barb effect, assure that it is almost impossible to pull the sealing disk off the workpiece. Mounting the sealing disk of the invention on the workpiece is quite simple, since only a small region of the sealing disk has to be deformed during the mounting. Special tools and great forces to attach the sealing disk to the workpiece are therefore unnecessary.

Because of the multilayer construction of the sealing disk with the comparatively soft sealing layers, good sealing action is nevertheless attained. With the sealing disk of the invention, the favorable properties of a soft material with regard to sealing are thus combined with the favorable properties of a rigid material for a reliable captive securing means. In addition, the comparatively high elasticity of steel contributes to the low vulnerability to impact of the sealing disk of the invention.

Because of the reduced likelihood of loss, consequent damage from installing a fuel injector, for instance, on an engine block without a sealing disk is prevented. Such consequent damage, caused by reduced sealing between the fuel injector and the combustion chamber, for instance takes the form of a loss of compression, seizing of the injector from carbonization of the interstice between the fuel injector and the engine block and in the worst case even destruction of the piston of the engine, and engine failure.

In general, an embodiment with two separate sealing disks, solidly or integrally joined to the support layer, should have the most advantages. However, it is also conceivable for a sealing layer and support layer of the same material to be located on one side.

An advantageously designed sealing disk includes steel as the material for the support layer and copper as the material for the sealing layers. In comparison to a sealing disk of pure copper, it is possible by means of the greater elastic deformation proportion of the steel support layer to effect an approximately 100% greater force that is required for pulling off the sealing disk from the workpiece, without reducing the sealing action that is furnished by the copper sealing layers, compared with a sealing disk of pure copper. In production, it is very simple to combine steel and copper into a layer composite, and in the production of the sealing disk of the invention its processability is likewise good.

The use of at least three lug-like projections that are distributed over the circumference of the inner opening in the sealing disk assures that when or after the sealing disk is slipped onto the workpiece, the edge of the inner opening does not rest on the workpiece and thus cannot be damaged. This is favorable for the sealing action and makes the manipulation of the unit formed by the sealing disk and the fuel injector easier, since this unit is comparatively robust.

The production of the sealing disk of the invention is simplified still further if the support layer and the sealing disk are at least approximately the same thickness. In the case of a copper sealing layer, however, it can be advantageous with a view to the function if this sealing layer is thicker than the support layer. In principle, the same total thicknesses of sealing disks as in the prior art can be created by varying the individual layer thicknesses, so that the sealing disk of the invention can be used without changing the corresponding workpiece. Because of the precise shaping of the geometry of the lug-like projections (thickness and width), even in a sealing disk of great thickness, the forces required to attach the sealing disk to the workpiece and to pull off or in other words to remove the sealing disk from the workpiece vary hardly at all from one sealing disk to another.

In a fuel injector of the invention, it is especially advantageous if the nozzle portion, in a first region bordering on the offset, has a lesser diameter than in a second region remote from the offset, and if the lug-like projection is designed such that after the sealing disk is slipped onto the nozzle portion, the lug-like projection relaxes elastically at least somewhat. In this way, the sealing disk is retained on the fuel injector not only by nonpositive engagement but also by positive engagement, which once again markedly increases the force required to pull off the sealing disk from the fuel injector, possibly even by more than 500%. One possible concrete embodiment of the region on the fuel injector with which the sealing disk, in the slipped-on state cooperates by positive engagement may comprise the embodiment of the first region of the nozzle portion as a conical undercut.

### DRAWINGS

Especially preferred exemplary embodiments of the present invention are described in further detail below in conjunction with the accompanying drawings. In the drawings:

FIG. 1 is a side view, partly in section, of a fuel injector with a sealing disk;

FIG. 2 is a plan view on the sealing disk of FIG. 1;

FIG. 3 is a section taken along the line III-III in FIG. 2;

FIG. 4 is a side view on a region of an alternative embodiment of a fuel injection device; and

FIG. 5 shows a detail V of FIG. 4.

### DESCRIPTION OF THE EXEMPLARY EMBODIMENTS

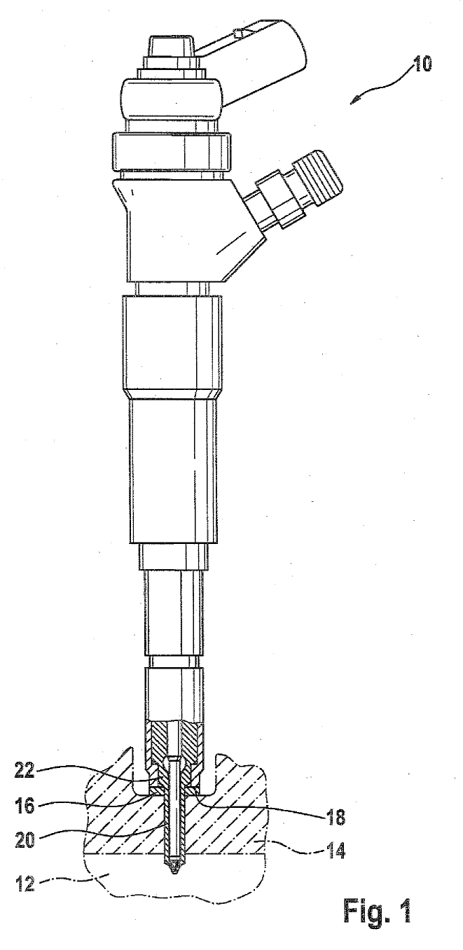

In FIG. 1, a fuel injector is identified overall by reference numeral 10. It serves to inject fuel into a combustion chamber 12, which is present in an engine block 14, shown only by dot-dashed lines, of an internal combustion engine (not identified by reference numeral). Securing the fuel injector 10 to the engine block 14 is done by means of screws, not shown in FIG. 1.

The fuel injector 10 is sealed off from the engine block 14 by means of a sealing disk 16, which in the installed position shown in FIG. 1 is clamped between the engine block 14 and an offset 18 on the fuel injector 10. The offset 18 is in turn formed between a nozzle portion 20 and a securing portion 22 of the fuel injector 10. The nozzle portion 20 has a smaller diameter than the securing portion 22.

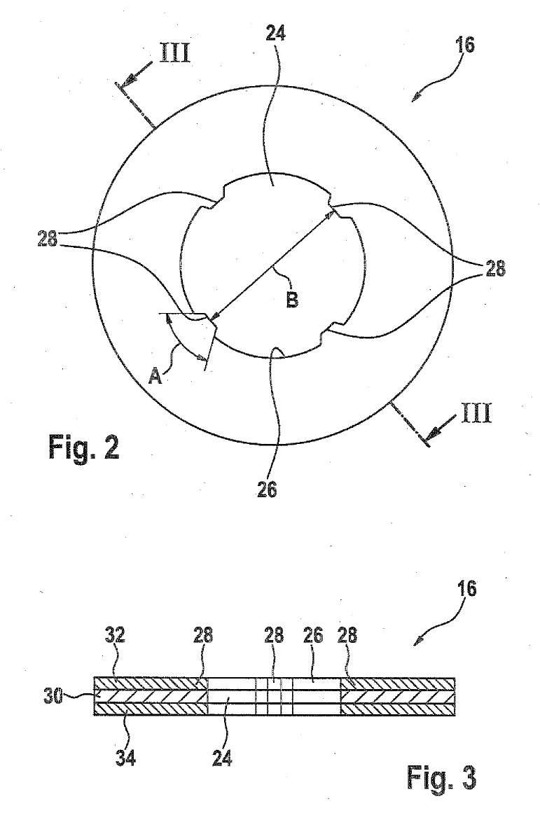

The sealing disk 16 is designed as follows (see FIGS. 2 and 3): In the plan view shown in FIG. 2, it is annular in shape, with an inner opening 24 that is defined essentially by an edge 26. A total of four radially inwardly extending lug-like projections 28 are distributed over the circumference of the inner opening 24, at its edge 26. By means of these projections, the inside diameter of the inner opening 24 is reduced by approximately 10%, compared to the edge 26. The lug-like projections 28 in the plan view of FIG. 2 are trapezoidal, with an angle A of approximately 60° between the lateral edges.

From the sectional view in FIG. 3, it can be seen that the sealing disk 16 in its axial direction is constructed of three layers, namely a middle support layer 30 of steel and two sealing layers 32 and 34 of copper, disposed on either side of the support layer 30. The sealing layers are joined solidly and in laminar fashion to the support layer 30. All three layers 30, 32 and 34 are of equal thickness in the present exemplary embodiment (in other exemplary embodiments, not shown, however, they may be of different thicknesses).

The sealing disk 16 cooperates with the fuel injector 10 as follows: The inside diameter B between diametrically opposed lug-like projections 28 is somewhat less than the outside diameter of the nozzle portion 20. The difference in diameter, in a typical application, is 1/10 of a millimeter. The inside diameter of the inner opening 24, outside the lug-like projections 28, is markedly greater than the diameter of the nozzle portion 20. Now, after the fuel injector 10 has been produced and before it is secured to the engine block 14, if the sealing disk 16 is slipped onto the nozzle portion 20 of the fuel injector 10, then the lug-like projections 28 are deformed elastically and rearward in terms of the direction in which they are attached.

Because of the great stiffness of the steel support layer 30 and because of their high elasticity, the lug-like projections 28 exert a considerable contact pressure against the wall of the nozzle portion 20. When the sealing disk 16 comes into contact with the offset 18, the sealing disk is retained in this position on the fuel injector 10 in a virtually captive fashion because of the positive engagement between the lug-like projections 28 and the nozzle portion 20. A further contribution to this is made by the fact that the lug-like projections 28 are bent elastically at high force counter to the only possible removal direction, so that in the manner of a barb, they either prevent the sealing disk 18 from being removed by being pulled off the fuel injector 10, or at least make such removal more difficult. It should be noted that in this state, despite the firm, nonpositive connection between the sealing disk 16 and the fuel injector 10, the edge 26 of the inner opening 24 outside the lug-like projections 28 does not touch the nozzle portion 20 of the fuel injector 10.

When the fuel injector 10 is now installed in the engine block 14, the sealing layer 32 is pressed against the offset 18 of the fuel injector 10, and the sealing disk 34 is pressed against the engine block 14. The comparatively soft copper material comprising the two sealing layers 32 and 34 thus assures good sealing between the fuel injector 10 and the engine block 14. It should be pointed out here that the sealing layers 32 and 34 could also be produced from different materials, to enable creating optimal seating to optionally different materials comprising the fuel injector 10 on the one hand and the engine block 14 on the other.

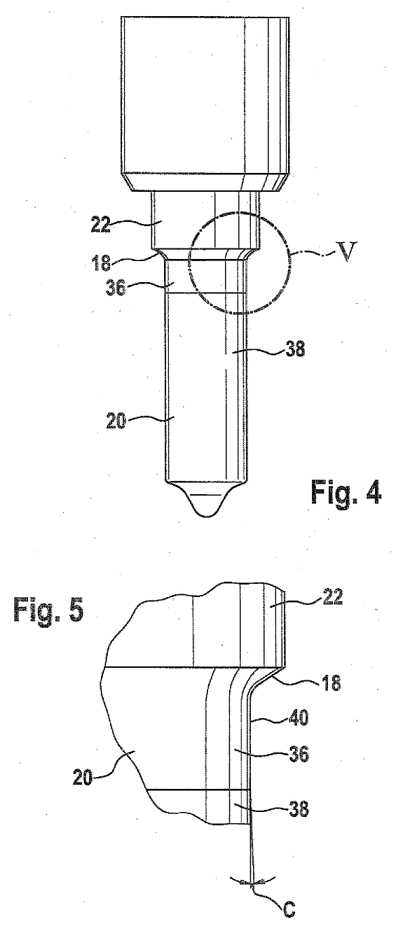

An alternative embodiment of a fuel injector 10 that is especially suitable for cooperation with the sealing disk shown in FIGS. 2 and 3 is shown in FIGS. 4 and 5. It should be pointed out here that those elements and regions that have equivalent functions to elements and regions of drawings already described are identified by the same reference numerals and will not be explained again in detail.

The nozzle portion 20 has a first portion 36, which borders directly on the offset 18. A second portion 38 of the nozzle portion 20 in turn borders the first portion 36 and is thus spaced apart from the offset 18. While the second portion 38 is made parallel to the longitudinal axis of the fuel injector 10, the first portion 36 is shaped slightly conically. An angle C between the two portions 36 and 38 is typically in the range of 1°. The first portion 36 thus forms a “undercut” 40.

As a result, whenever the sealing disk 16 is slipped onto the nozzle portion 20, the lug-like projections 28 in the region of the first portion 36 spring elastically back somewhat in the direction of their nondeformed outset position. Thus between the sealing disk 16 and the fuel injector 10, not only a nonpositive connection but a positive connection as well are created, which further markedly increases the force that would be needed to pull off the sealing disk 16 from the fuel injector 10.

1-8. (canceled)

9. A sealing disk (16), in particular for sealing off a fuel injector (10) with respect to an engine block (14) of an internal combustion engine, comprising:
at least one support layer (30);
at least two sealing layers (32, 34) disposed on both sides of the support layer (30), the support layer (30) comprising a stiffer material than the sealing layers (32, 34); and
a captive securing means (28) for captive retention of the sealing disk (16) on a workpiece, in particular a fuel injector (10), the captive securing means being disposed on a peripheral edge (26) of an inner through opening (24) of the sealing disk (16) and being embodied by at least one radially inwardly extending lug-like projection (28).

10. The sealing disk according to claim 9, wherein the support layer (30) includes steel.

11. The sealing disk according to claim 9, wherein the sealing layers (32, 34) include copper.

12. The seating disk according to claim 10, wherein the sealing layers (32, 34) include copper.

13. The sealing disk according to claim 9, further comprising at least three lug-like projections (28) distributed over the circumference of the inner opening (24).

14. The sealing disk according to claim 10, further comprising at least three lug-like projections (28) distributed over the circumference of the inner opening (24).

15. The sealing disk according to claim 11, further comprising at least three lug-like projections (28) distributed over the circumference of the inner opening (24).

16. The sealing disk according to claim 9, wherein the support layer (30) and the sealing layers (32, 34) are at least approximately the same thickness.

17. The sealing disk according to claim 10, wherein the support layer (30) and the sealing layers (32, 34) are at least approximately the same thickness.

18. The sealing disk according to claim 11, wherein the support layer (30) and the sealing layers (32, 34) are at least approximately the same thickness.

19. The sealing disk according to claim 12, wherein the support layer (30) and the sealing layers (32, 34) are at least approximately the same thickness.

20. The sealing disk according to claim 13, wherein the support layer (30) and the sealing layers (32, 34) are at least approximately the same thickness.

21. A fuel injector comprising:
a nozzle portion (20) having a first diameter;
a securing portion (22) having a second diameter greater than the first diameter of the nozzle portion (20);
an offset (18) formed between the nozzle portion (20) and the securing portion (22); and
a sealing disk (16) retained on the nozzle portion (20) against the offset (18), the sealing disk having
at least one support layer (30),
at least two sealing layers (32, 34) disposed on both sides of the support layer (30), the support layer (30) comprising a stiffer material than the sealing layers (32, 34), and
a captive securing means (28) for captive retention of the sealing disk (16) on the nozzle portion (20) of the fuel injector, the captive securing means being disposed on a peripheral edge (26) of an inner through opening (24) of the sealing disk (16) and being embodied by at least one radially inwardly extending lug-like projection (28), wherein the sealing disk (16) is retained on the nozzle portion (20) at least by the action of the lug-like projection (28).

22. The fuel injector according to claim 21, wherein the support layer (30) includes steel.

23. The fuel injector according to claim 21, wherein the sealing layers (32, 34) include copper.

24. The fuel injector according to claim 22, wherein the sealing layers (32, 34) include copper.

25. The fuel injector according to claim 21, further comprising at least three lug-like projections (28) distributed over the circumference of the inner opening (24).

26. The fuel injector according to claim 21, wherein the support layer (30) and the sealing layers (32, 34) are at least approximately the same thickness.

27. The fuel injector according to claim 21, wherein the nozzle portion (20), in a first region (36) bordering on the offset (18), has a lesser diameter than in a second region (38) remote from the offset (18) and that the lug-like projection (28) is designed such that it relaxes elastically at least somewhat after the sealing disk (16) is slipped onto the nozzle portion (20).

28. The fuel injector according to claim 27, wherein the first region (36) includes a conical undercut (40).
